(19) United States
(12) Patent Application Publication
(10) Pub. No.: US 2018/0341264 A1
(43) Pub. Date: Nov. 29, 2018

(54) AUTONOMOUS-VEHICLE CONTROL SYSTEM

(71) Applicant: Ford Global Technologies, LLC, Dearborn, MI (US)

(72) Inventor: Matthew Aaron Knych, Dearborn, MI (US)

(73) Assignee: Ford Global Technologies, LLC, Dearborn, MI (US)

(21) Appl. No.: 15/603,494

(22) Filed: May 24, 2017

(51) Int. Cl. G05D 1/02; G05D 1/00; G01S 19/13

(52) U.S. Cl. CPC G05D 1/0214; G05D 1/0088; G05D 1/0231; H04L 67/12; G05D 1/0055; G01S 19/13; G05D 1/0022

(57) ABSTRACT

A computer is programmed to receive, from a vehicle control device, data specifying a location of the control device outside a vehicle; receive data specifying a spatial boundary; generate a path avoiding the spatial boundary from a current location of the vehicle to a location within a predetermined distance of the control-device location; and navigate the vehicle along the path.

### BACKGROUND

An autonomous mode is a mode of operation for a vehicle in which each of a propulsion, a brake system, and a steering of the vehicle are controlled by one or more computers; in a semi-autonomous mode computer(s) of the vehicle control(s) one or two of the propulsion, braking, and steering. By way of context, the Society of Automotive Engineers (SAE) has defined multiple levels of autonomous vehicle operation. At levels 0-2, a human driver monitors or controls the majority of the driving tasks, often with no help from the vehicle. For example, at level 0 (“no automation”), a human driver is responsible for all vehicle operations. At level 1 (“driver assistance”), the vehicle sometimes assists with steering, acceleration, or braking, but the driver is still responsible for the vast majority of the vehicle control. At level 2 (“partial automation”), the vehicle can control steering, acceleration, and braking under certain circumstances without human interaction. At levels 3-5, the vehicle assumes more driving-related tasks. At level 3 (“conditional automation”), the vehicle can handle steering, acceleration, and braking under certain circumstances, as well as monitoring of the driving environment. Level 3 requires the driver to intervene occasionally, however. At level 4 (“high automation”), the vehicle can handle the same tasks as at level 3 but without relying on the driver to intervene in certain driving modes. At level 5 (“full automation”), the vehicle can handle almost all tasks without any driver intervention. The vehicle may operate in one or more of the levels of autonomous vehicle operation.

Movement of an autonomous vehicle can be controlled by and/or governed according to a user and/or a location of a user. One problem that arises in the context of controlling autonomous vehicles with respect to users outside the vehicle is preventing the vehicle from traveling into restricted areas. For example, a vehicle could be programmed to follow a user, and the user could walk into a restricted area.

### BRIEF DESCRIPTION OF THE DRAWINGS

FIG. 1 is a block diagram of an example autonomous vehicle and an example control device.

FIG. 2 is a network graph of exemplary modes of the autonomous vehicle.

FIG. 3 is a diagram of the autonomous vehicle operating in an exemplary environment.

FIG. 4 is a process flow diagram of an exemplary process for determining a spatial boundary for the autonomous vehicle.

FIG. 5 is a process flow diagram of an exemplary process for operating the autonomous vehicle.

### DETAILED DESCRIPTION

The system described below allows a vehicle to follow a user while avoiding restricted areas, with minimal oversight by the user. The system includes a computer and sensors for autonomous operation of the vehicle, as well as a control device. The computer is programmed to receive data from the control device for demarcating a spatial boundary in the memory of the computer. The computer is further programmed to control the vehicle to follow the user while preventing the vehicle from crossing the spatial boundary. The system provides a convenient way for a user to perform work while having the vehicle continually close to the user. Moreover, advantageously, the system solves the problem of how to have the vehicle avoid restricted areas that lack visual markings.

A computer is programmed to receive, from a vehicle control device, data specifying a location of the control device outside a vehicle; receive data specifying a spatial boundary; generate a path avoiding the spatial boundary from a current location of the vehicle to a location within a predetermined distance of the control-device location; and navigate the vehicle along the path.

The computer may be further programmed to receive a series of boundary locations, and to determine the spatial boundary by connecting the boundary locations in the series. The computer may be further programmed to enter a boundary-reception mode upon receiving an input to enter the boundary-reception mode before receiving the series of boundary locations, and to exit the boundary-reception mode upon receiving a command to complete the spatial boundary before generating the path.

The computer may be further programmed to receive property-line data, and to determine the spatial boundary according to the property-line data.

The computer may be further programmed to receive real-time visual data; detect, from the visual data, a physical boundary between a first ground area that is predominantly a first color and a second ground area that is predominantly a second color; and emit an alert that the path crosses the physical boundary. The computer may be further programmed to receive operator input granting permission to cross the physical boundary, and navigate along the path across the physical boundary upon receiving the input granting permission.

The computer may be further programmed to determine that an obstacle is in the path, and adjust the path to avoid the obstacle and the spatial boundary.

The data indicating the control-device location may include Global Positioning System data.

The data indicating the control-device location may include object detection data.

The computer may be further programmed to enter a follow mode upon receiving an input to enter the follow mode before navigating along the path, to exit the follow mode upon receiving an input to stop following, and to refrain from navigating along the path upon exiting the follow mode.

A method includes receiving, from a vehicle control device, a signal indicating a location of the control device outside a vehicle; receiving data specifying a spatial boundary; generating a path avoiding the spatial boundary from a current location of the vehicle to a location within a predetermined distance of the control-device location; and navigating the vehicle along the path.

The method may include receiving a series of boundary locations, and determining the spatial boundary by connecting the boundary locations in the series. The method may include entering a boundary-reception mode upon receiving an input to enter the boundary-reception mode before receiving the series of boundary locations, and exiting the boundary-reception mode upon receiving a command to complete the spatial boundary before determining the spatial boundary.

The method may include receiving property-line data, and determining the spatial boundary according to the property-line data.

The method may include receiving real-time visual data; detecting, from the visual data, a physical boundary between a first ground area that is predominantly a first color and a second ground area that is predominantly a second color; and emitting an alert that the path crosses the physical boundary. The method may include receiving operator input granting permission to cross the physical boundary, and following the path across the physical boundary upon receiving the input granting permission.

The method may include determining that an obstacle is in the path, and adjusting the path to avoid the obstacle and the spatial boundary.

The data indicating the operator location may include Global Positioning System data.

The data indicating the operator location may include object detection data.

The method may include entering a follow mode upon receiving an input to enter the follow mode before navigating along the path, exiting a follow mode upon receiving an input to stop following, and refraining from navigating the path upon exiting the follow mode.

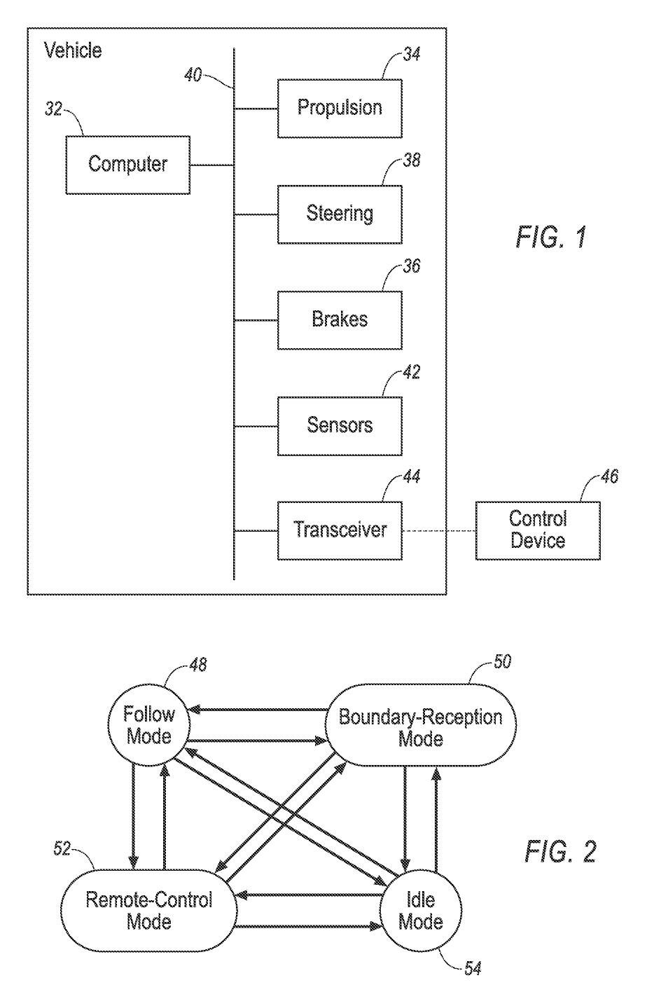

With reference to FIG. 1, a vehicle 30 is an autonomous vehicle. The vehicle 30 may be any machine capable of moving under its own power. The vehicle 30 includes a computer 32 capable of operating the vehicle 30 independently of the intervention of a human driver, completely or to a lesser degree. The computer 32 may be programmed to operate a propulsion 34, brake system 36, steering 38, and/or other vehicle systems. For the purposes of this disclosure, autonomous operation is defined to occur when each of a propulsion 34, a brake system 36, and a steering 38 of the vehicle are controlled by the computer 32, and semi-autonomous operation is defined to occur when one or two of the propulsion 34, brake system 36, and steering 38 are controlled by the computer 32.

The computer 32 is a microprocessor-based computer. The computer 32 includes a processor, a memory, etc. The memory of the computer 32 includes memory for storing instructions executable by the processor as well as for electronically storing data and/or databases.

The computer 32 may transmit signals through a communications network 40 such as a controller area network (CAN) bus, Ethernet, Local Interconnect Network (LIN), and/or by any other wired or wireless communications network. The computer 32 may be in communication with the propulsion 34, the brake system 36, the steering 38, sensors 42, and a transceiver 44.

The propulsion 34 of the vehicle 30 generates energy and translates the energy into motion of the vehicle 30. The propulsion 34 may be a known vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion 34 can include an electronic control unit (ECU) or the like that is in communication with and receives input from the computer 32 and/or a human driver. The human driver may control the propulsion 34 via, e.g., an accelerator pedal and/or a gear-shift lever or a control device 46 remote from the vehicle 30.

The brake system 36 is typically a known vehicle braking subsystem and resists the motion of the vehicle 30 to thereby slow and/or stop the vehicle 30. The brake system 36 may be friction brakes such as disc brakes, drum brakes, band brakes, etc.; regenerative brakes; any other suitable type of brakes; or a combination. The brake system 36 can include an electronic control unit (ECU) or the like that is in communication with and receives input from the computer 32 and/or a human driver. The human driver may control the brake system 36 via, e.g., a brake pedal or the control device 46.

The steering 38 is typically a known vehicle steering subsystem and controls the turning of the wheels. The steering 38 may be a rack-and-pinion system with electric power-assisted steering, a steer-by-wire system, as both are known, or any other suitable system. The steering 38 can include an electronic control unit (ECU) or the like that is in communication with and receives input from the controller and/or a human driver. The human driver may control the steering 38 via, e.g., a steering wheel or the control device 46.

The vehicle 30 includes the sensors 42. The sensors 42 may provide data about operation of the vehicle 30, for example, wheel speed, wheel orientation, and engine and transmission data (e.g., temperature, fuel consumption, etc.). The sensors 42 may detect the position or orientation of the vehicle 30. For example, the sensors 42 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 42 may detect the external world. For example, the sensors 42 may include radar sensors, scanning laser range finders, light detection and ranging (LIDAR) devices, and image processing sensors such as cameras. The sensors 42 may transmit real-time 3-dimensional data and/or real-time visual data to the computer 32 via the communications network 40.

The transceiver 44 can transmit signals wirelessly through any suitable wireless communication protocol, such as Bluetooth®, WiFi, IEEE 802.11a/b/g, other RF (radio frequency) communications, etc. The transceiver 44 can thereby communicate with a remote server, that is, a server distinct and geographically distant, e.g., one or many miles, from the vehicle 30. The remote server is typically located outside the vehicle 30. For example, the remote server may be associated with other vehicles (e.g., V2V communications), infrastructure components (e.g., V2I communications), emergency responders, the control device 46 associated with the owner of the vehicle 30, etc. The transceiver 44 may be one device or may include a separate transmitter and receiver.

With continued reference to FIG. 1, the control device 46 is a microprocessor-based computer, i.e., including a processor, a memory, etc. The memory may store instructions executable by the processor as well as data, e.g., as discussed herein. The control device 46 may be a single computer or may be multiple computers in communication. The control device 46 may be in, e.g., a mobile device such as a smartphone or tablet, which is equipped for wireless communications, e.g., via a cellular network and/or a wireless protocol such as 802.11a/b/g and/or Bluetooth®. The control device 46 communicates with the transceiver 44.

With reference to FIG. 2, the computer 32 may have different modes 48, 50, 52, 54 in which the computer 32 can operate. For the purposes of this disclosure, a mode 48, 50, 52, 54 is defined as programming for a set of operations and responses to inputs that are performed when the computer 32 is in that mode 48, 50, 52, 54 and not performed when the computer 32 is in another of the modes 48, 50, 52, 54. For example, the modes 48, 50, 52, 54 may include a follow mode 48, a boundary-reception mode 50, a remote-control mode 52, and an idle mode 54. As illustrated by the arrows in FIG. 2, the computer 32 may be programmed to exit one mode 48, 50, 52, 54 and enter another mode 48, 50, 52, 54 upon receiving an input to do so, e.g., from the control device 46. In the follow mode 48, the computer 32 may be programmed to instruct the vehicle 30 to follow a user 56 carrying the control device 46 as the user 56 moves around, as described below with respect to a process 500. In the boundary-reception mode 50, the computer 32 may be programmed to receive inputs defining a spatial boundary 72, as described below with respect to a process 400. In the remote-control mode 52, the computer 32 may be programmed to move the vehicle 30 in response to inputs to the control device 46 of commands directly to the propulsion 34, brake system 36, and steering 38. In other words, in the remote-control mode 52, the user 56 operates the propulsion 34, brake system 36, and steering 38, rather than the vehicle 30 moving autonomously. In the idle mode 54, the computer 32 may be programmed to keep the vehicle 30 stationary.

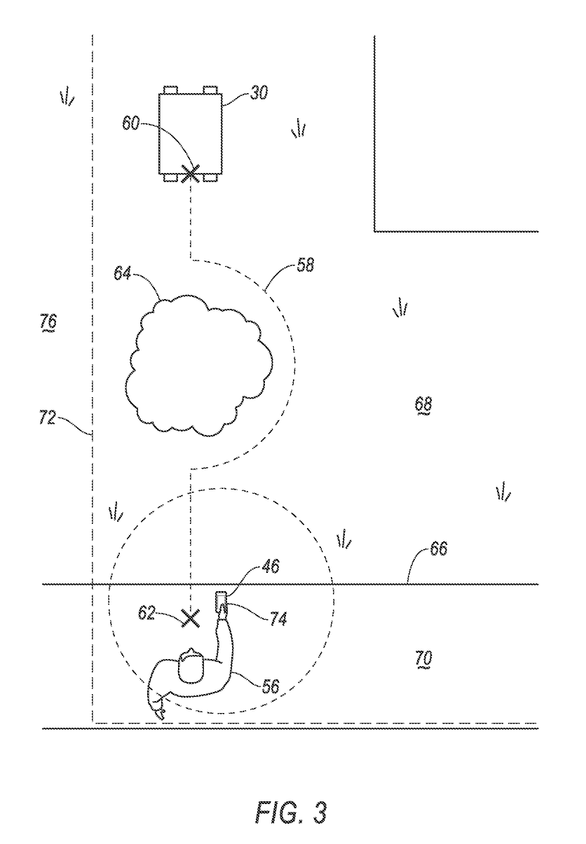

FIG. 3 illustrates an exemplary scene in which the vehicle 30 operates. A user 56 holds the control device 46. A path 58 extends from a current location 60 of the vehicle 30 to a destination location 62 within a predetermined distance from the user 56. The path 58 extends around an obstacle 64, e.g., a bush, and the path 58 extends across a physical boundary 66, e.g., from a lawn 68 to a sidewalk 70. For the purposes of this disclosure, an obstacle 64 is an object or landscape feature that the vehicle 30 is incapable of driving over. For the purposes of this disclosure, a physical boundary 66 is a curve or surface extending through space and defined by features of the environment, but over which the vehicle 30 is capable of driving. The computer 32 may determine that the vehicle 30 is incapable of driving over an object or feature if the object or feature is taller than a ground clearance of the vehicle 30 or wider than a tire-to-tire clearance of the vehicle 30. A spatial boundary 72, i.e., a boundary on one side of which is a restricted area 76 in which the vehicle 30 is to be prevented from traveling, extends along the lawn 68 and along the sidewalk 70. For the purposes of this disclosure, a spatial boundary 72 is defined as a curve or surface extending through and having a defined location in space. For the purposes of this disclosure, a restricted area 76 is defined as an area that the vehicle 30 is supposed to avoid traveling through. The restricted area 76 is on the opposite side of the spatial boundary 72 from the vehicle 30.

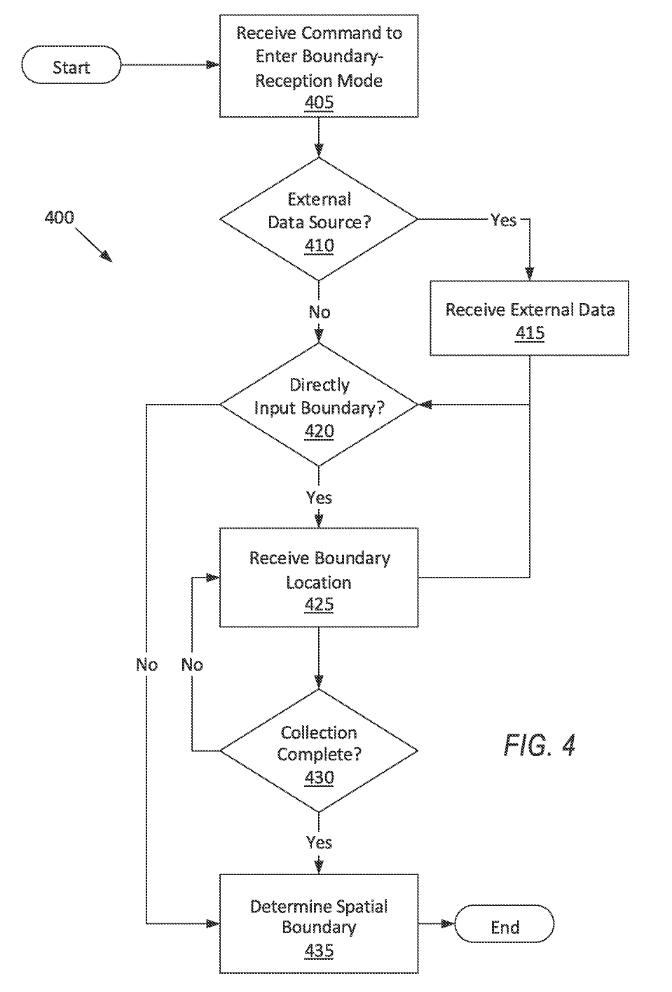

FIG. 4 is a process flow diagram illustrating an exemplary process 400 for determining a spatial boundary 72 for the vehicle 30. The steps of the process 400 may be stored as program instructions in the memory of the computer 32. The computer 32 may be programmed to perform the steps of the process 400 when the computer 32 is in the boundary-reception mode 50.

The process 400 begins in a block 405, in which the computer 32 enters the boundary-reception mode 50 upon receiving an input from the user 56 to enter the boundary-reception mode 50. The input may be received from the control device 46 via the transceiver 44.

Next, in a decision block 410, the computer 32 determines whether to receive data about the spatial boundary 72 from an external source. For example, the computer 32 may check whether the computer 32 has received an input from the control device 46 specifying one or more external sources from which the computer 32 can receive data. For the purposes of this disclosure, an external source of data is defined as a server remote from the computer 32 and from the control device 46 that is storing geographic data such as the remote server described above. Examples of data stored on external sources include surveying maps, public records of property lines, etc. For example, property boundaries, street boundaries, parking lot boundaries, etc. could be specified according to conventional geo-coordinates. If the computer 32 does not have an external source from which to receive data about the spatial boundary 72, the process 400 proceeds to a decision block 420.

If the computer 32 has an external source from which to receive data about the spatial boundary 72, next, in a block 415, the computer 32 receives the data from the external source. For example, the computer 32 may receive property-line data or survey data describing a property boundary.

After the block 415 or, if the computer 32 does not have an external source from which to receive data about the spatial boundary 72, after the decision block 410, in the decision block 420, the computer 32 determines whether to receive boundary locations from the control device 46. For example, the computer 32 may check whether the computer 32 has received an input from the control device 46 specifying that the user 56 will enter boundary locations. If the computer 32 will not receive boundary locations, the process 400 proceeds to a block 435.

If the computer 32 will receive boundary locations, next, in a block 425, the computer 32 receives a boundary location. The boundary location is a geographic coordinate received from the control device 46. The boundary location may be entered into the control device 46 in any manner in which geographic coordinates can be represented. For example, the boundary location may be a current control-device location 74 of the control device 46. The control device 46 may send the control-device locations 74, e.g., at regular intervals or whenever the user 56 enters a command to send the control-device location 74. For another example, the user 56 could select the boundary location on a map displayed by the control device 46. For another example, the user 56 could enter geographic coordinates, e.g., longitude and latitude or local coordinates, into the control device 46. For another example, the user 56 may enter locations in the control device 46 that are measured relative to the current location 60 of the vehicle 30, e.g., a location 30 feet in front of and 30 feet to the left of the vehicle 30.

Next, in a decision block 430, the computer 32 determines whether all the boundary locations have been entered. For example, the computer 32 may check whether the computer 32 has received an input from the control device 46 indicating that all the boundary locations have been entered. If the boundary locations have not all been entered, the process 400 returns to the block 425 to receive the next boundary location. The computer 32 repeats the blocks 425 and 430 to receive a series of boundary locations until all the boundary locations have been entered. For example, if the series of boundary locations are a series of control-device locations 74 of the control device 46 sent to the computer 32 as the user 56 walks around holding the control device 46, then the control device 46 may send the control-device locations 74, e.g., at regular intervals or whenever the user 56 enters a command to send the control-device location 74. For another example, if the user 56 selects the boundary locations on a map displayed by the control device 46 by, e.g., marking a line on the map, then the control device 46 may send the locations of the endpoints of the line or may send the locations of points periodically spaced along the line.

After the decision block 420, if the computer 32 does not receive boundary locations, or after the decision block 430, if the computer 32 has received all the boundary locations, in the block 435, the computer 32 determines the spatial boundary 72 based on the data from the external source and/or the series of boundary locations. For example, the computer 32 may determine the spatial boundary 72 by connecting the boundary locations in the series. For another example, the computer 32 may determine the spatial boundary 72 according to geo-coordinates specifying property lines and/or boundaries from surveying data. For another example, the computer 32 may combine a spatial boundary 72 based on an external source and a spatial boundary 72 based on boundary locations by connecting the spatial boundaries 72 if the spatial boundaries 72 intersect or cross within a threshold distance of each other. The threshold distance may be chosen to be sufficiently short that a user 56 likely intends the property line and the series of boundary locations to be a single spatial boundary 72. The threshold distance may be, e.g., a width of the vehicle 30. If the computer 32 does not receive data from an external source and does not receive a series of boundary locations, the computer 32 may determine that no spatial boundary 72 is to be created. After the block 435, the process 400 ends.

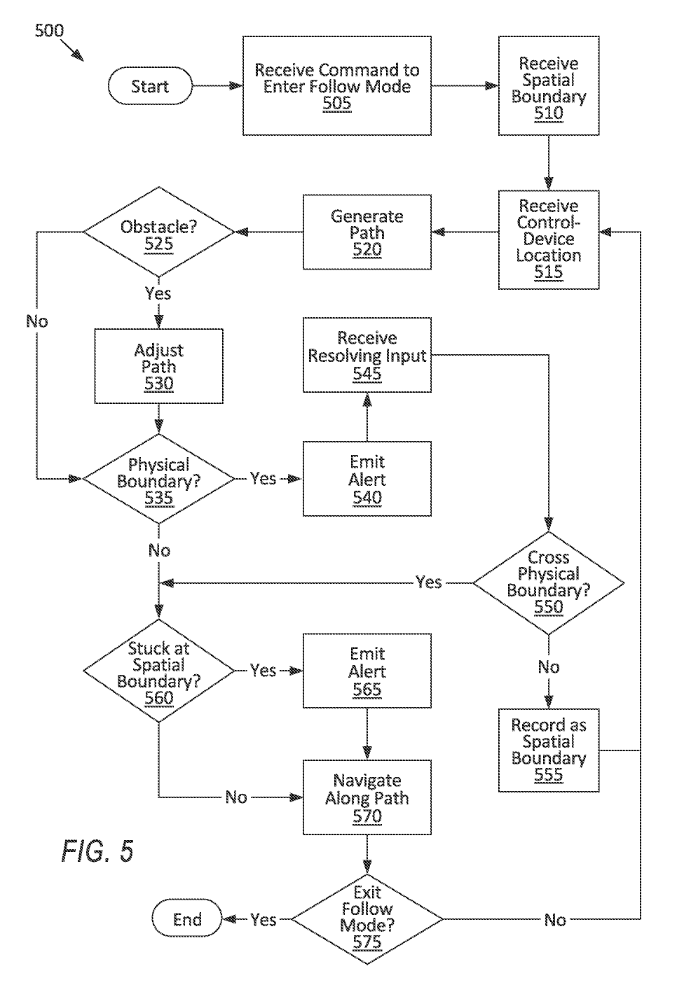

FIG. 5 is a process flow diagram illustrating an exemplary process 500 for operating the vehicle 30. The steps of the process 500 may be programmed on the computer 32. The computer 32 may be programmed to perform the steps of the process 500 when the computer 32 is in the follow mode 48.

The process 500 begins in a block 505, in which the computer 32 enters the follow mode 48 upon receiving an input to enter the follow mode 48. The input may be received from the control device 46 via the transceiver 44.

Next, in a block 510, the computer 32 receives data specifying the spatial boundary 72. The data may be pre-stored and retrieved from the memory of the computer 32. For example, the data may be generated as described above with respect to the process 400. For another example, the data may be downloaded from a remote server, e.g., if the data was created by a party other than the user 56.

Next, in a block 515, the computer 32 receives data specifying a location, e.g., in terms of conventional geo-coordinates, of the control device 46, i.e., the control-device location 74. The data may be received from the control device 46, via the transceiver 44. The data indicating the control-device location 74 may include Global Positioning System data. The data indicating the control-device location 74 may include object detection data, e.g., visual data from the sensors 42 from which a human shape, presumed to be the user 56, may be detected by the computer 32.

Next, in a block 520, the computer 32 generates a path 58 avoiding the spatial boundary 72 from the current location 60 of the vehicle 30 to the destination location 62 within the predetermined distance of the control-device location 74. In other words, the path 58 and the spatial boundary 72 do not intersect. The spatial boundary 72 may have a buffer zone, i.e., a distance from the spatial boundary 72 that the vehicle 30 should not cross. The buffer zone may be stored in the memory of the computer 32. The buffer zone may be chosen based on a function of the vehicle 30; for example, if the vehicle 30 is spreading fertilizer, the buffer zone may equal a distance from the vehicle 30 that the vehicle 30 spreads the fertilizer. The path 58 may be generated using any suitable path-planning algorithm, such as Dijkstra's algorithm, A*, D*, and others, as are known, using the spatial boundary 72 as a constraint. The path 58 may be chosen, e.g., to be the shortest path between the current location 60 and the destination location 62, or the path 58 may be optimized along another measurement besides travel distance.

Next, in a decision block 525, the computer 32 determines whether an obstacle 64 is in the path 58, i.e., whether the vehicle 30 will impact the obstacle 64 while traveling along the path 58. The computer 32 may receive data from the sensors 42, such as visual data and/or 3-dimensional mapping data, from which to locate obstacles 64, and may use known techniques for classifying and/or identifying obstacles. If the computer 32 does not detect an obstacle 64, the process 500 proceeds to a decision block 535.

If the computer 32 determines that there is an obstacle 64 in the path 58, next, in a block 530, the computer 32 adjusts the path 58 to avoid the obstacle 64 and the spatial boundary 72. The computer 32 may adjust the path 58, e.g., to be the shortest path between the current location 60 and the destination location 62 that allows the vehicle 30 to travel around the obstacle 64 without impacting the obstacle 64, while still not intersecting, i.e., crossing, the spatial boundary 72. The computer 32 may use known path-planning algorithms using the spatial boundary 72 and the obstacle 64 as constraints.

After the decision block 525, if the computer 32 does not detect an obstacle 64, or after the block 530, in the decision block 535, the computer 32 detects, from the visual data, whether there is a physical boundary 66 that the path 58 crosses and that the vehicle 30 will therefore cross if the vehicle 30 travels the path 58. For example, the computer 32 may detect the physical boundary 66 between a first ground area that is predominantly a first color, e.g., a lawn 68 that is green, and a second ground area that is predominantly a second color, e.g., a sidewalk 70 that is gray. For another example, the computer 32 may detect the physical boundary 66 between the first ground area that predominantly has a first value of reflectivity or light absorption and the second ground area that predominantly has a second value of reflectivity or light absorption. For another example, the computer 32 may detect the physical boundary 66 between the first ground area and the second ground area divided by a change in elevation having a slope above a threshold, e.g., 75°. The computer 32 may only detect the physical boundary 66 if the first and second ground areas have a width or area above a threshold, e.g., a width or area of the vehicle 30. If the computer 32 does not detect a physical boundary 66, the process 500 proceeds to a decision block 560.

If the computer 32 detects a physical boundary 66, next, in a block 540, the computer 32 emits an alert that the path 58 crosses the physical boundary 66. The alert may be in any form that is detectable by the user 56, for example, a beep from the vehicle 30, a message sent to the control device 46, etc. The vehicle 30 may also travel along the physical boundary 66 without crossing to, e.g., a location closest to the destination location 62.

Next, in a block 545, the computer 32 receives a resolving input. The vehicle 30 does not cross the physical boundary 66 until the computer 32 receives the resolving input. The resolving input is feedback allowing the computer 32 to resolve where the vehicle 30 should travel. For example, the resolving input may be an instruction entered into the control device 46 by the user 56 and sent to the computer 32, such as an operator input granting permission to cross the physical boundary 66. For another example, the user 56 may move, and the path 58 from the current location 60 to the destination location 62 may no longer cross the physical boundary 66.

Next, in a decision block 550, the computer 32 determines whether the resolving input granted permission to cross the physical boundary 66. If the resolving input granted permission to cross the physical boundary 66, the process 500 proceeds to the block 560.

If the resolving input does not grant permission to cross the physical boundary 66, next, in a block 555, the computer 32 records the physical boundary 66 as a spatial boundary 72. After the block 555, the process 500 returns to the block 515.

After the decision block 535, if the computer 32 does not detect a physical boundary 66, or after the block 550, if the resolving input granted permission to cross the physical boundary 66, in a decision block 560, the computer 32 determines whether the vehicle 30 is stuck at a spatial boundary 72. In other words, the computer 32 determines whether the vehicle 30 cannot move closer to the control-device location 74 without crossing a spatial boundary 72. If the vehicle 30 is not stuck at a spatial boundary 72, the process 500 proceeds to a block 570.

If the vehicle 30 is stuck at the spatial boundary 72, next, in a block 565, the computer 32 emits an alert that the path 58 crosses the spatial boundary 72. The alert may be in any form that is detectable by the user 56, for example, a beep from the vehicle 30, a message sent to the control device 46, etc.

Next, in the block 570, the computer 32 navigates the vehicle 30 along the path 58. If the user 56 granted permission to cross the physical boundary 66 in the block 545, the computer 32 navigates along the path 58 across the physical boundary 66.

Next, in a decision block 575, the computer 32 determines whether to exit the follow mode 48. The computer 32 may exit the follow mode 48 if the computer 32 has received an input instructing the computer 32 to exit the follow mode 48, that is, stop following, or instructing the computer 32 to enter another of the modes 50, 52, 54. Upon exiting the follow mode 48, the computer 32 refrains from navigating along the path 58. If the computer 32 exits the follow mode 48, the process 500 ends. If the computer 32 is not exiting the follow mode 48, the process 500 returns to the block 515. In other words, as long as the computer 32 is in the follow mode 48, the computer 32 dynamically performs the blocks 515-575, meaning that as the user 56 moves around, the computer 32 regenerates the path 58 to follow the user 56, avoiding obstacles 64, emitting alerts at physical boundaries 66, etc.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer, programmed to:
receive, from a vehicle control device, data specifying a location of the control device outside a vehicle;
receive data specifying a spatial boundary;
generate a path avoiding the spatial boundary from a current location of the vehicle to a location within a predetermined distance of the control-device location; and
navigate the vehicle along the path.

2. The computer of claim 1, further programmed to receive a series of boundary locations, and to determine the spatial boundary by connecting the boundary locations in the series.

3. The computer of claim 2, further programmed to enter a boundary-reception mode upon receiving an input to enter the boundary-reception mode before receiving the series of boundary locations, and to exit the boundary-reception mode upon receiving a command to complete the spatial boundary before generating the path.

4. The computer of claim 1, further programmed to receive property-line data, and to determine the spatial boundary according to the property-line data.

5. The computer of claim 1, further programmed to:
receive real-time visual data;
detect, from the visual data, a physical boundary between a first ground area and a second ground area; and
emit an alert that the path crosses the physical boundary.

6. The computer of claim 5, further programmed to receive operator input granting permission to cross the physical boundary, and navigate along the path across the physical boundary upon receiving the operator input granting permission.

7. The computer of claim 1, further programmed to determine that an obstacle is in the path, and adjust the path to avoid the obstacle and the spatial boundary.

8. The computer of claim 1, wherein the data indicating the control-device location includes Global Positioning System data.

9. The computer of claim 1, wherein the data indicating the control-device location includes object detection data.

10. The computer of claim 1, further programmed to enter a follow mode upon receiving an input to enter the follow mode before navigating along the path, to exit the follow mode upon receiving an input to stop following, and to refrain from navigating along the path upon exiting the follow mode.

11. A method comprising:
receiving, from a vehicle control device, a signal indicating a location of the control device outside a vehicle;
receiving data specifying a spatial boundary;
generating a path avoiding the spatial boundary from a current location of the vehicle to a location within a predetermined distance of the control-device location; and
navigating the vehicle along the path.

12. The method of claim 11, further comprising receiving a series of boundary locations, and determining the spatial boundary by connecting the boundary locations in the series.

13. The method of claim 12, further comprising entering a boundary-reception mode upon receiving an input to enter the boundary-reception mode before receiving the series of boundary locations, and exiting the boundary-reception mode upon receiving a command to complete the spatial boundary before determining the spatial boundary.

14. The method of claim 11, further comprising receiving property-line data, and determining the spatial boundary according to the property-line data.

15. The method of claim 11, further comprising:
receiving real-time visual data;
detecting, from the visual data, a physical boundary between a first ground area and a second ground area; and
emitting an alert that the path crosses the physical boundary.

16. The method of claim 15, further comprising receiving operator input granting permission to cross the physical boundary, and following the path across the physical boundary upon receiving the operator input granting permission.

17. The method of claim 11, further comprising determining that an obstacle is in the path, and adjusting the path to avoid the obstacle and the spatial boundary.

18. The method of claim 11, wherein the data indicating the control-device location includes Global Positioning System data.

19. The method of claim 11, wherein the data indicating the control-device location includes object detection data.

20. The method of claim 11, further comprising entering a follow mode upon receiving an input to enter the follow mode before navigating along the path, exiting the follow mode upon receiving an input to stop following, and refraining from navigating the path upon exiting the follow mode.
